(19) United States
(12) Patent Application Publication
(10) Pub. No.: US 2004/0042940 A1
(43) Pub. Date: Mar. 4, 2004

(54) Plasma reactor gas processing

(76) Inventors: Peter James Andrews, Wantage Oxfordshire (GB); Stephen Ivor Hall, Oxford (GB); Michael Inman, Abingdon (GB); Christopher David John Manson-Whitton, Oxford (GB); James Timothy Shawcross, Charlbury (GB); David Michael Weeks, Abingdon (GB)

Correspondence Address: William H Holt, Law Offices of William H Holt, Unit 2 First Floor, 1423 Powhatan Street, Alexandria, VA, 22314, US

(21) Appl. No.: 10/416,704

(22) PCT Filed: Dec. 6, 2001
(86) PCT No.: PCT/GB01/05414

(30) Foreign Application Priority Data
Dec. 15, 2000 (GB) 0030749.6

(51) Int. Cl. B01J 19/08

(52) U.S. Cl. 422/186.04; 422/186.21

(57) ABSTRACT

A reactor (100) for the plasma assisted processing of a gaseous medium, including a cylindrical bed (106) of active material (107) contained between two concentric electrodes (108, 109), both of which are earthed and with a third cylindrical electrode (111) concentric with the other electrodes positioned within the bed of active material (107) and connected to a high voltage input terminal (112).

The present invention relates to the plasma-assisted processing of gaseous media and in particular to the reduction of the emission of carbonaceous and nitrogenous oxide combustion products from the exhausts of internal combustion engines.

One of the major problems associated with the development and use of internal combustion engines is the noxious exhaust emissions from such engines. Two of the most deleterious materials, particularly in the case of diesel engines, are particulate matter (primarily carbon) and oxides of nitrogen (NOₓ). Increasingly severe emission control regulations are forcing internal combustion engine and vehicle manufacturers to find more efficient ways of removing these materials in particular from internal combustion engine exhaust emissions. Unfortunately, in practice, it is found that combustion modification techniques which improve the situation in relation to one of the above components of internal combustion engine exhaust emissions tend to worsen the situation in relation to the other. Even so, a variety of systems for trapping particulate emissions from internal combustion engine exhausts have been investigated, particularly in relation to making such particulate emission traps capable of being regenerated when they have become saturated with particulate material.

Examples of such diesel exhaust particulate filters are to be found in European patent applications EP 0 010 384; U.S. Pat. Nos. 4,505,107; 4,485,622; 4,427,418; and 4,276,066; EP 0 244 061; EP 0 112 634 and EP 0 132 166.

In all the above cases, the particulate matter is removed from diesel exhaust gases by a simple, physical trapping of particulate matter in the interstices of a porous, usually ceramic, filter body, which is then regenerated by heating the filter body to a temperature at which the-trapped diesel exhaust particulates are burnt off. In most cases the filter body is monolithic, although EP 0 010 384 does mention the use of ceramic beads, wire meshes or metal screens as well. U.S. Pat. No. 4,427,418 discloses the use of ceramic coated wire or ceramic fibres.

GB patent 2,274,412 discloses a method and apparatus for removing particulate and other pollutants from internal combustion engine exhaust gases, in which the exhaust gases are passed through a bed of charged pellets of material, preferably ferroelectric, having high dielectric constant. In addition to removing particulates by oxidation, especially electrical discharge assisted oxidation, there is disclosed the reduction of NOₓ gases to nitrogen, by the use of pellets adapted to catalyse the NOₓ reduction.

A problem which arises with plasma assisted gas reactors which include a bed of pellets of a high-dielectric constant material, such as that disclosed in specification GB 2 274 412, is that localised variations in the electric field in the pellet bed can occur, possibly leading to regions of the pellet bed in which the electric field is insufficient to enable a plasma to be established in a gaseous medium to be processed in the reactor.

It is an object of the present invention to provide an improved reactor for the plasma-assisted processing of gaseous media.

According to the present invention there is provided a reactor for the plasma assisted processing of a gaseous medium comprising a reactor chamber containing a gas permeable active material, means for constraining a gaseous medium to be processed in the reactor to pass through the chamber and the active material therein and a plurality of electrodes by means of which there can be established across the active material an electric field sufficient to establish a plasma in the gaseous medium passing through the interstices in the active material, wherein there is included at least one electrode connected to a high voltage input terminal and positioned within the active material between two parallel electrodes connected to an earth point.

The active material may comprise a bed of active material, preferably material having a high dielectric permittivity.

An advantage of the electrode arrangement of the present invention is that for a given width of a bed of pellets of active medium, the electric field is doubled, thus improving the efficiency of the production of a plasma in a gaseous medium passing through the bed of active material in the reactor.

Preferably the bed of active material has a hollow cylindrical configuration, and coaxial cylindrical electrodes form the inner and outer surfaces of the cylinder and the high voltage electrode is positioned halfway between the earthed electrodes and co-axial therewith.

In a preferred embodiment of the invention the bed of active material is in the form of individual pellets contained between two concentric cylindrical earthed electrodes, the high voltage electrode also is a cylindrical electrode concentric with the earthed electrodes and situated halfway between the earthed electrodes, the electrodes are gas permeable, the gaseous medium is constrained to flow radially through the bed of active material and the pellets on the upstream side of the high voltage electrode have a larger size than those on the downstream side of the high voltage electrode.

In a particular aspect of the present invention the plasma assisted gas reactor is adapted to be incorporated into the exhaust system of an internal combustion engine for the removal of nitrogenous and/or carbonaceous combustion products therefrom. In this form of the invention there may be included downstream of the plasma assisted gas reactor a catalytic converter for the further reduction of the concentration of noxious combustion products in the exhaust gases from the internal combustion engine.

The catalytic converter may be included in the same reactor chamber as the active material. In particular it can be included in the central region of a bed of active material, when that has a cylindrical configuration.

Examples of suitable materials for use as the active material are titanates, particularly barium titanate, titania, particularly in the anatase phase, zirconia and mixtures of these compounds, aluminas, metal-doped zeolites, and vanadia.

The invention will now be described, by way of example, with reference to the accompanying drawings, in which,

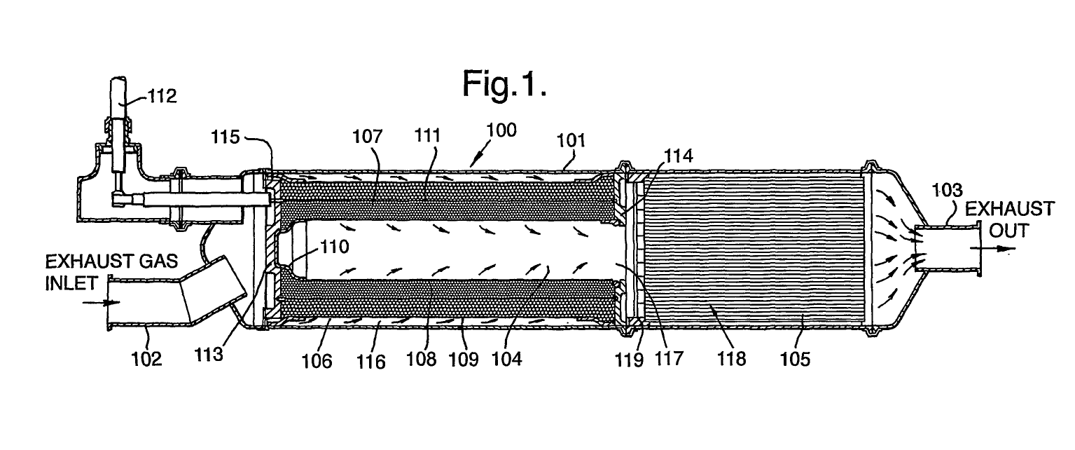

FIG. 1 is a longitudinal section of a first embodiment of the invention,

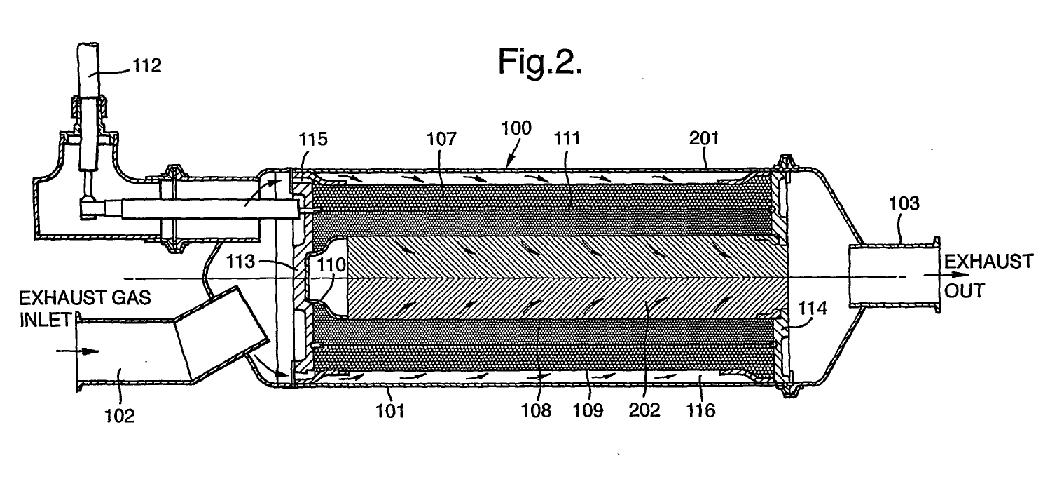

FIG. 2 is a longitudinal section of a second embodiment of the invention,

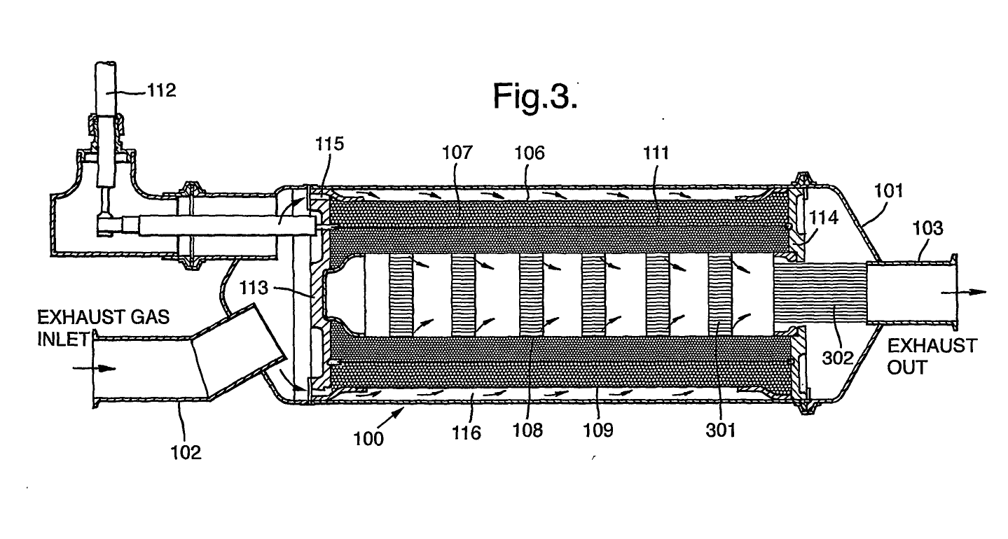

FIG. 3 is a longitudinal section of a third embodiment of the invention,

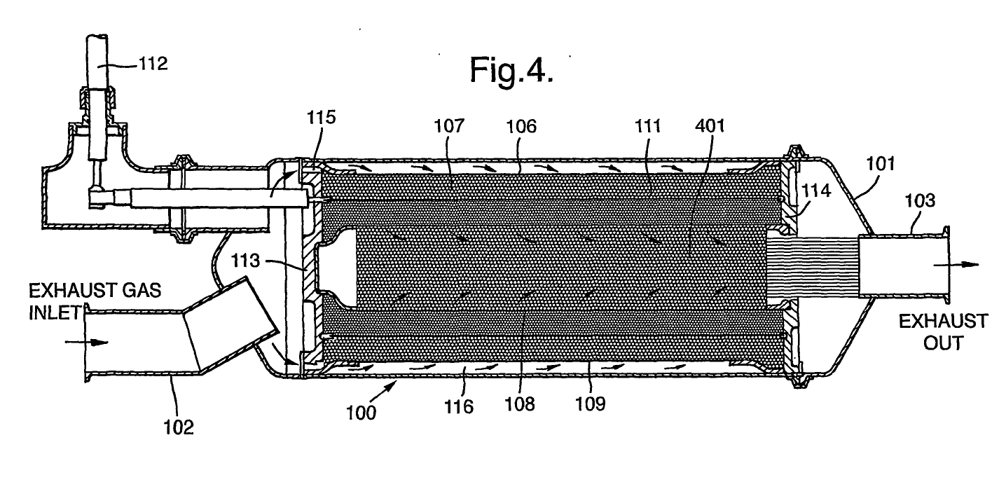

FIG. 4 is a longitudinal section of a fourth embodiment of the invention,

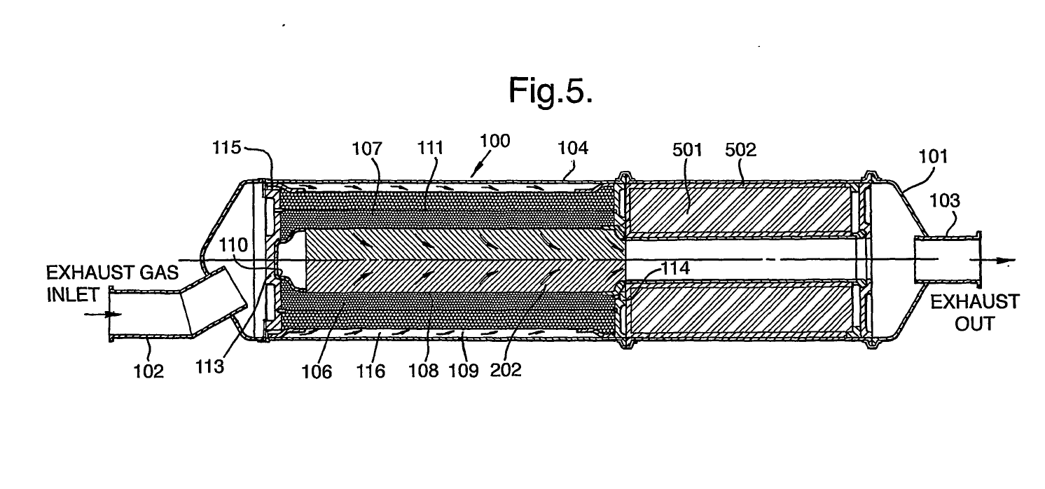

FIG. 5 is a longitudinal section of a fifth embodiment of the invention,

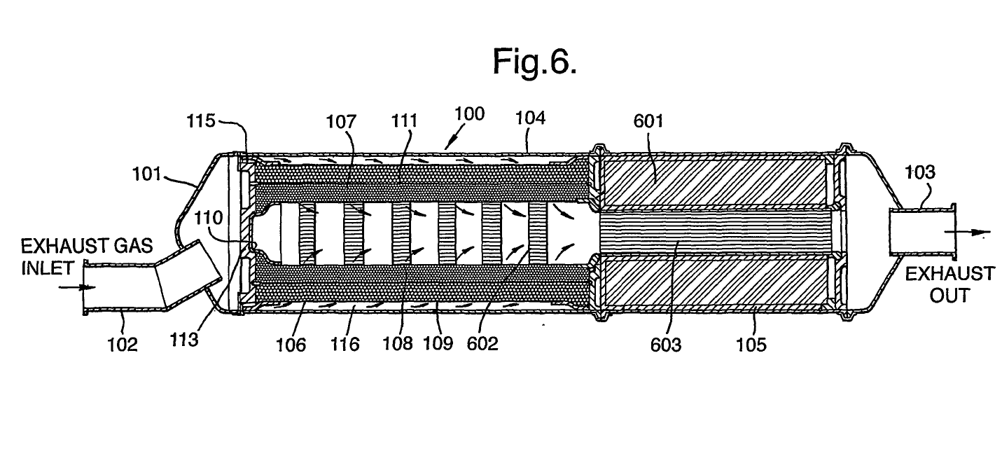

FIG. 6 is a longitudinal section of a sixth embodiment of the invention, and

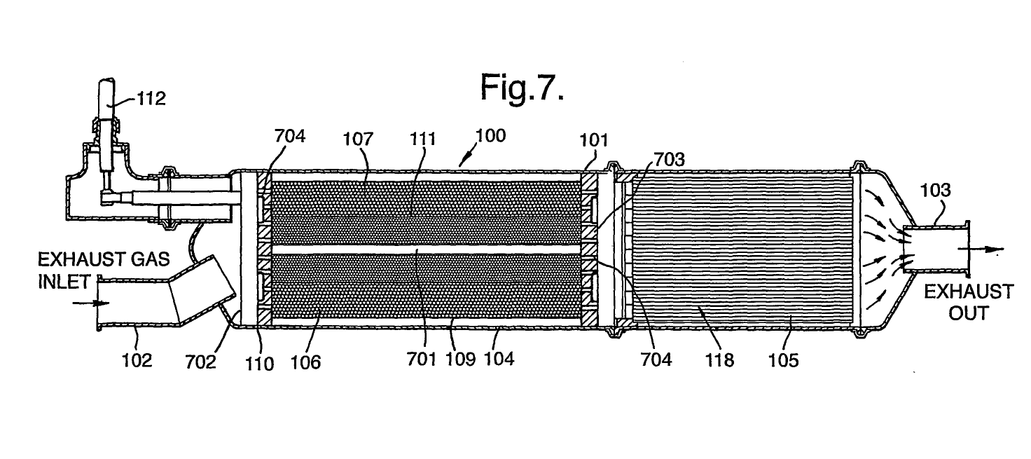

FIG. 7 is a longitudinal section of a seventh embodiment of the invention,

Referring to FIG. 1, a reactor 100 for the plasma assisted treatment of the exhaust gases from an internal combustion engine to remove noxious combustion products therefrom consists of a cylindrical metal casing 101 which has an inlet stub 102 and an outlet stub 103 by means of which it can be incorporated into the exhaust system of an internal combustion engine. (Not shown in the figure). The reactor casing 101 is divided into two compartments 104, 105. The upstream compartment 104 of the reactor casing 101 includes a bed 106 of pellets 107 of an active material, such as barium titanate, which is contained between two earthed concentric cylindrical electrodes 108, 109 made of perforated stainless steel. The upstream end of the inner electrode 108, is closed by a thimble 110, also made of stainless steel. Situated centrally within the bed 106 of pellets 107 of active material, concentric with the electrodes 108 and 109, is a third cylindrical electrode 111, also made of perforated stainless steel. The electrode 111 is connected to a high voltage terminal 112. The electrodes 108, 109 and 111 are supported and located in the compartment 104 of the reactor casing 101 by two diaphragms 113 and 114 made of a ceramic insulating material which is resistant to thermal shock, such as alumina. The upstream electrode support 113 has a ring of regularly spaced axially oriented holes 115 around its periphery which open into a space 116 between the reactor casing 101 and the outer electrode 109. The downstream electrode support 114 has a central aperture 117 the diameter of which is approximately equal to that of the inner electrode 108. Thus, exhaust gases entering the reactor chamber 101 are constrained to pass radially through the bed 106 of pellets 107 before leaving the compartment 104 of the reactor casing 101 through the central aperture 117 in the inner earthed electrode 108. The compartment 105 of the reactor 100 contains a conventional monolith catalyst body 118 for the reduction of exhaust emissions from internal combustion engines. Between the compartments 104, 105 of the reactor casing 101 there is a flow director plate 119 which is arranged to ensure that the flow of exhaust gases leaving the compartment 104 of the reactor casing 101 through the aperture 117 in the electrode 108 is expanded to encompass the whole upstream surface 120 of the catalyst body 118.

FIG. 2 shows a longitudinal section of a second embodiment of the invention. Those components which correspond with similar components of the first embodiment have the same reference numerals. In this embodiment of the invention the reactor casing 101 has only one compartment 201 and a monolithic body of catalytic material 202 is contained within the inner electrode 108. The remainder of the device is the same as the device of FIG. 1.

FIG. 3 shows a longitudinal section of a third embodiment of the invention. Again, components which are similar to those of previous embodiments have the same reference numerals. In this embodiment of the invention, again there is a monolithic catalyst within the inner electrode 108, but in this case, the catalyst is in the form of a series of disks 301 instead of a single body and there is a second body 302 of catalyst situated between the aperture 117 in the second electrode 114 and the outlet stub 103 of the reactor casing 101.

FIG. 4 shows another embodiment of the invention in which the space inside the inner electrode 108 is filled with beads 401 of catalytic material instead of a number of disks of monolithic catalyst. The remainder of the reactor is the same as for the FIG. 3 embodiment of the invention and bears the same reference numerals.

FIG. 5 shows an embodiment of the invention in which the high voltage electrode 111 is connected directly to a thermally protected high voltage transformer 501 which has a hollow cylindrical form and is contained in a second compartment 502 of the reactor casing 101. Again the space within the inner electrode 108 is filled with a monolithic catalyst 202 for the further reduction of noxious components of internal combustion engine exhaust gases.

FIG. 6 shows another embodiment of the invention which has the high voltage electrode connected directly to the output from a high voltage transformer 601. In this case, however, the space inside the inner electrode 108 has a plurality of disks 602 of monolithic catalytic material, as in the embodiment described with reference to FIG. 3, and the inside of the hollow cylindrical transformer 601 is filled with another body 603 of monolithic catalytic material.

The embodiments of the invention described so far are all configured to provide for a substantially radial flow of the gaseous medium through the bed 106 of pellets 107 of active material. However, plasma assisted gas processing reactors embodying the invention can be configured to provide an axial flow though the bed of active material of a gaseous medium to be processed in the reactor.

FIG. 7 shows one such arrangement. Again, those components which are similar to corresponding components of the first embodiment have the same reference numerals. Referring to FIG. 7, the inner electrode 108 is replaced by a central rod 701 and the electrode supports 113 and 114 are replaced by corresponding electrode supports 702, 703 which are either made of a readily gas permeable insulating ceramic material or which have an array of axial holes 704 in them. Also, the outer earthed electrode 109 and high voltage electrode 111 are made of unperforated stainless steel sheet. The baffle plate 119 is not required and is omitted. The remainder of the reactor is the same as for the FIG. 1 embodiment.

The configuration of the FIG. 7 embodiment lends itself to adaptation for dielectric barrier discharge operation. For this, at least the high voltage electrode is provided on all surfaces with a layer of dielectric material to form the dielectric barrier. Alternatively both earth electrodes are provided on all surfaces with a layer of dielectric material. However, a preferred arrangement for dielectric barrier discharge operation is for all the electrodes to be provided on all surfaces with a layer of dielectric material.

It will be appreciated that the radial flow embodiments of FIGS. 1 to 6 can be similarly adapted for dielectric barrier discharge operation, but, in that case, the design of the electrodes is more difficult since, in providing for gas passage through the electrodes, care is required to ensure that all metal surfaces are coated with a layer of dielectric barrier material.

1. A reactor for the plasma assisted processing of a gaseous medium comprising a reactor chamber containing a gas permeable active material, means for constraining a gaseous medium to be processed in the reactor to pass through the chamber and the active material and a plurality of electrodes by means of which there can be established across the active material an electric field sufficient to establish a plasma in the gaseous medium passing through the interstices in the active material, wherein there is included at least one electrode connected to a high voltage input terminal and positioned within the active material between two parallel electrodes connected to an earth point.

2. A reactor according to claim 1, wherein the high voltage electrode is coated on all surfaces with a dielectric material so that the reactor operates as a dielectric barrier reactor.

3. A reactor according to claim 1 or claim 2, wherein the earthed electrodes are coated on at least the surfaces facing the high voltage electrode with a dielectric material so that the reactor operates as a dielectric barrier reactor.

4. A reactor according to claim 1 or claim 2 or claim 3, wherein the reactor has a hollow cylindrical configuration, the two earthed electrodes form the inner and outer boundaries of the active material and the high voltage electrode is a cylinder positioned halfway between the inner and outer electrodes and co-axial therewith.

5. A reactor according to any of the preceding claims, wherein the permeability of the active material decreases in the direction of flow of the gaseous medium through the active material.

6. A reactor according to any of the preceding claims, wherein the active material is in the form of an agglomeration of individual pellets of the active material.

7. A reactor according to claim 6 wherein the size of the pellets decreases in the direction of flow of the gaseous medium through the reactor.

8. A reactor according to any of claims 4 to 7, wherein the electrodes are gas permeable and the gaseous medium is constrained to pass radially through the reactor chamber.

9. A reactor according to any of the preceding claims, wherein the reactor is adapted to form part of the exhaust system of an internal combustion engine.

10. A reactor according to claim 9 in association with a body of material having catalytic properties for the reduction of noxious combustion products in the exhaust gases from an internal combustion engine.

11. A reactor according to claim 10 wherein the body of the said catalytic material is positioned downstream of the active material.

12. A reactor according to claim 10 or claim 11, wherein the active material has a hollow cylindrical configuration, the gaseous medium is constrained to pass radially through the active material and the said catalytic material is positioned in the hollow centre of the active material.

13. A reactor according to any of the preceding claims, wherein the high voltage electrode is connected directly to a source of high potential contained in a compartment of the same envelope as the active material.

14. A reactor according to claim 13, wherein the high potential source has a hollow cylindrical configuration and a bed of gas permeable material catalytic for the reduction of noxious emissions from the exhaust gases of internal combustion engines is contained in the hollow centre of the high potential source.
